(19) United States
(12) Patent Application Publication
(10) Pub. No.: US 2025/0335923 A1
(43) Pub. Date: Oct. 30, 2025

(54) Systems and Methods for Detecting Network Rerouting

(71) Applicant: The PNC Financial Services Group, Inc., Pittsburgh, PA (US)

(72) Inventors: Nicole HINKOFER, Pittsburgh, PA (US); Jeremy JANTSCH, Pittsburgh, PA (US); Anthony LATOUR, Pittsburgh, PA (US)

(21) Appl. No.: 19/192,829

(22) Filed: Apr. 29, 2025

Related U.S. Application Data
(60) Provisional application No. 63/639,902, filed on Apr. 29, 2024.

(51) Int. Cl. G06Q 20/40; G06Q 20/02; G06Q 20/20; G06Q 20/32; G06Q 40/02

(52) U.S. Cl. CPC G06Q 20/407; G06Q 20/027; G06Q 20/20; G06Q 20/325; G06Q 40/02

(57) ABSTRACT

Devices and methods are provided for identifying a financial transaction that has bypassed a stop payment request on a first payment rail system by using a second payment rail system. Such bypassed transactions may be identified using transactional event data associated with the original stop payment request on the previously-used network rail, and corrective action may then be undertaken. In particular, new transactional event data and the original stop payment request data may be analyzed to determine if the new payment card financial transaction matches a prior payment card financial transaction for which stop payment requests have been issued.

### CROSS-REFERENCE TO RELATED APPLICATIONS

The present application claims priority to U.S. Provisional Application No. 63/639,902, filed Apr. 29, 2024, which is incorporated herein by reference in its entirety.

### BACKGROUND

In a networked environment, certain communications are expected to traverse a predetermined network channel. In such an arrangement, a system may monitor that predetermined channel to identify an expected communication and take action when that expected communication is detected. In some instances, a transmitting entity may transmit that communication via a second, unexpected channel. Should that happen, the system's monitoring of the predetermined channel would fail to identify the expected communication such that the intended action upon detection would not occur.

### SUMMARY

In view of the foregoing, systems and methods are provided herein that may be used to identify when a stop payment request has been bypassed by a merchant, such as when a merchant changes payment rails (e.g., switching from the Visa payment rail to the STAR PIN payment rail) and the stop payment request was specific to the previously-used payment rail. In particular, using the techniques described herein, such “bypassed transactions” may be identified using transactional event data associated with the original stop payment request on the previously-used payment rail, and corrective action may then be undertaken. For example, a stop payment request may then be placed on the new payment rail and remedial steps may be taken, such as to notify and refund the user. Among other advantages, the systems and methods described herein can help to improve card user experience by allowing for the rapid detection of transactions that have bypassed a stop payment request by using a second network rail.

In one aspect, the present disclosure provides one or more computer storage media storing computer-readable instructions that when executed by one or more processors, cause the one or more processors to perform operations. The operations may include receiving transactional event data associated with a new payment card financial transaction processed using a first payment rail system and receiving stop payment request data that includes transactional event data associated with multiple prior payment card financial transactions for which stop payment requests have been issued, wherein at least a portion of the multiple financial transactions are processed using a second payment rail system. The operations may further include analyzing the new transactional event data and the stop payment request data to determine if the new payment card financial transaction matches a prior payment card financial transaction for which a stop payment request has been issued and generating an alert if the new payment card financial transaction matches a prior payment card financial transaction for which a stop payment request has been issued.

In another aspect, the present disclosure provides a computer-implemented method for identifying a financial transaction that has bypassed a stop payment request. The method may include the following operations performed by at least one processor: receiving transactional event data associated with a new payment card financial transaction processed using a first payment rail system; receiving stop payment request data that includes transactional event data associated with multiple prior payment card financial transactions for which stop payment requests have been issued, wherein at least a portion of the multiple financial transactions are processed using a second payment rail system; analyzing the new transactional event data and the stop payment request data to determine if the new payment card financial transaction matches a prior payment card financial transaction for which a stop payment request has been issued; and generating an alert if the new payment card financial transaction matches a prior payment card financial transaction for which a stop payment request has been issued.

In yet another aspect, the present disclosure provides a tangible, non-transitory computer-readable memory device that stores a set of instructions that, when executed by at least one processor, cause the at least one processor to perform operations. The operations may include receiving transactional event data associated with a new payment card financial transaction processed using a first payment rail system and receiving stop payment request data that includes transactional event data associated with multiple prior payment card financial transactions for which stop payment requests have been issued, wherein at least a portion of the multiple financial transactions are processed using a second payment rail system. The operations may further include analyzing the new transactional event data and the stop payment request data to determine if the new payment card financial transaction matches a prior payment card financial transaction for which a stop payment request has been issued and generating an alert if the new payment card financial transaction matches a prior payment card financial transaction for which a stop payment request has been issued.

In still another aspect, the present disclosure provides a system for identifying a financial transaction that has bypassed a stop payment request. The system may include means for storing transactional event data associated with a new payment card financial transaction processed using a first payment rail system and means for storing stop payment request data that includes transactional event data associated with multiple prior payment card financial transactions for which stop payment requests have been issued. At least a portion of the multiple financial transactions in the stop payment request data may have been processed using a second payment rail system. The system may further include means for analyzing the stored new transactional event data and the stop payment request data to determine if the new payment card financial transaction matches a prior payment card financial transaction for which a stop payment request has been issued. Further still, the system may include means for generating an alert signal if the new payment card financial transaction matches a prior payment card financial transaction for which a stop payment request has been issued.

In one aspect, a secure payments network is provided. The secure payments network may include a secure network device software package configured to enable a secure network device to selectively transmit payment card transactional data to one or more secure end points across a first secure network that includes a first secure end point addressable by a first end point identifier and a second secure end point addressable by a second end point identifier, and a second secure network that is logically separate and distinct from the first secure network, wherein the first and second secure end points are addressable on the second secure network. The secure payments network may also include one or more processors within the first secure end point and coupled to at least one data store storing instructions, which when loaded into at least one memory and executed by the one or more processors cause the one or more processors to receive first transactional event data involving a first transactional event via the first secure network, receive a stop payment instruction associated with the first transactional event, analyze second transactional event data involving a plurality of second transactional events received from the second secure network to determine if a match exists between the second transactional events and the first transactional event associated with the stop payment instruction, and generate an alert upon determining that any of the plurality of second transactional events correspond with the stop instruction request associated with the first transactional event.

In yet another aspect, the present provides a secure payments network. The secure payments network may include one or more processors within a first secure end point and coupled to at least one data store storing instructions, which when loaded into at least one memory and executed by the one or more processors cause the one or more processors to receive first transactional event data involving a first transactional event via a first secure network, the first secure network that includes a first secure end point addressable by a first end point identifier and a second secure end point addressable by a second end point identifier, receive a stop payment instruction associated with the first transactional event, analyze second transactional event data involving a plurality of second transactional events received from a second secure network to determine if a match exists between the second transactional events and the first transactional event associated with the stop payment instruction, wherein the second secure network is logically separate and distinct from the first secure network and the first and second secure end points are addressable on the second secure network, and generate an alert upon determining that any of the plurality of second transactional events correspond with the stop instruction request associated with the first transactional event.

The current subject matter will be better understood by reference to the following detailed description when considered in combination with the accompanying drawings which form part of the present specification.

### BRIEF DESCRIPTION OF DRAWINGS

FIG. 1 is a diagram depicting a debit card transaction system.

FIG. 2 is a diagram depicting a stop payment request being bypassed on a second payment rail in a debit card transaction system.

FIG. 3 depicts an operational flowchart of a technique for identifying a financial transaction that has bypassed a stop payment request.

FIG. 4 is a diagram depicting a matching process between a dataset containing stop payment request transactional event data and transactional event data associated with new payment card financial transactions.

FIG. 5 depicts an operational flowchart of corrective actions that may be taken once a financial transaction that has bypassed a stop payment request has been identified.

FIG. 6 depicts a flowchart of an example process for identifying and addressing stop payment requests that have been bypassed on a second payment rail in a debit card transaction system.

FIG. 7 depicts a computer-implemented method for identifying a financial transaction that has bypassed a stop payment request.

### DETAILED DESCRIPTION

The following disclosure provides many different aspects, or examples, for implementing different features of the provided subject matter. Specific examples of components and arrangements are described below to simplify the present disclosure. These are, of course, merely examples and are not intended to be limiting.

As discussed above, payment rails provide a path for providing payment from the cardholder to the merchant. When a payment card is used for a transaction, the merchant's card terminal sends the transaction details to a processor, which is often the acquiring bank. The processor then communicates with a payment rail associated with the payment to verify the card's validity, as well as the available funds in the case of debit cards or the credit limit in the case of credit cards. If approved, the transaction is authorized, and the merchant can proceed with the sale. The acquiring bank later settles the funds with the merchant, while the issuing bank settles with the merchant bank and bills the cardholder for the transaction amount. This may be reflected as either a direct deduction from a cardholder's bank account (for debit cards) or an addition to their credit card balance (for credit cards).

The payment rails provide the infrastructure that enable the transfer of funds and information between various parties involved in the payment card transaction. The payment rails include major payment processors and card networks such as Visa, Mastercard, American Express, Discover, Interlink, STAR, and PULSE. Payment rails provide the technical and operational framework for authorization, processing, clearing, and settlement of everyday transactions, by facilitating communication between the various parties involved in the transaction process.

In some instances, a cardholder may make a request to stop a payment from being completed. Stop payment requests are instructions given by a cardholder to their issuing bank to prevent a specific transaction from being processed on a payment rail. These requests are typically made when the cardholder wants to cancel a pending payment or subscription, prevent a recurring payment, block a suspicious transaction, or dispute a charge. The cardholder may contact their bank either online, over the phone, or through written communication to initiate the stop payment request, providing details such as the transaction amount, date, and merchant information. Once the request is received, the bank takes action to halt the payment process by informing the network rail (e.g., Visa, STAR) of the stop payment request, thereby ensuring that the specified transaction does not go through. Stop payment requests offer cardholders a degree of control over their transactions, allowing them to manage their finances and prevent unauthorized or undesired charges.

When a stop payment request is made, the issuing bank is instructed not to pay out funds associated with the specified payment. Through a payment rail's services, issuing banks and financial institutions can place stop payment instructions in the payment rail system. When an eligible transaction is matched to a stop payment instruction (e.g., during authorization or settlement of a transaction), a decline response code may inform the processor that the cardholder has withdrawn their consent for payment to be taken from the card. Acquiring banks may pass this decline response code through to the merchant, so that they know not to resubmit the authorization request. If the transaction is submitted subsequent times for clearing and settlement, the payment rail may again match the stop payment instruction with the transaction and return a decline response code to the acquirer.

As noted above, individual payment cards may access more than one payment rail. For example, credit and debit cards may access two or more payment rails, providing cardholders with a range of options for making transactions. The number of payment rails available to a payment card depends on various factors, including the issuing bank's partnerships, the card network affiliation, and regional considerations. For example, in addition to credit transactions, many debit cards support PIN-based debit transactions, which are processed through PIN debit networks that allow the cardholder to enter a personal identification number (PIN) at the point of sale to authorize the transaction securely. Once the PIN is entered, the transaction details, including the encrypted PIN, are sent to the merchant's acquiring bank. The acquiring bank then determines the appropriate PIN debit network rail for processing the transaction based on factors such as the card's network affiliation and the merchant's relationship with the network. The acquiring bank sends an authorization request to the selected PIN debit network rail, which in turn routes the request to the cardholder's bank (issuing bank) for approval.

By having access to multiple network rails, cardholders may benefit from increased flexibility, broader acceptance, and enhanced transaction capabilities. Recognizing this, the U.S. Federal Reserve Board has enacted updates to Regulation II, which now specifies that debit card issuers in the U.S. should enable at least two unaffiliated network rails to process all debit card transactions, including “card-not-present” transactions, such as online payments. These regulations also have benefits to merchants. Multiple payment rails via unaffiliated networks mitigate issues with “network exclusivity,” where merchants can select payment rails that best match their business needs (e.g., cost, time to settlement, security, global reach, reliability and support). By offering multiple routing options, merchants can select the best network for processing transactions, which can help reduce transaction costs and promote competition among payment rails. Moreover, with the requirement to enable at least two unaffiliated network rails, point-of-sale devices and online payment gateways may implement new processes that make it even easier for the merchant to either manually or automatically select which network rail will be used for a given transaction.

The availability of multiple payment rails may result in that merchants and processors switching between various network rails when completing transactions (e.g., online eCommerce transactions) to get the “best deal” for their current situation. In most instances, a merchant switching payment rails would not be perceptible to the consumer. Again, the payment rails function as a secure network with secure end points at the financial institutions (e.g., the issuing bank and the acquiring bank). The secure end points maintain databases that store records (e.g., card account balances and transaction histories associated) that are identifiable by network identifiers (e.g., card numbers, account numbers) and the end points themselves are addressable by network identifiers (e.g., routing numbers, wire numbers). If the payment cards are required to enable at least two unaffiliated payment rails, this effectively leads to multiple payment rails being coupled at the merchant end, even though each payment rail is designed to operate in isolation from each other.

While beneficial to merchants, the present disclosure recognizes that payment rail changes pose a potential problem. Specifically, because stop payment requests are typically specific to a single payment rail, the risk that a stop payment request may be intentionally or inadvertently bypassed during a merchant payment rail change has increased. For example, if a stop payment request is placed on a Visa network rail for a recurring payment, and the merchant changes to the STAR PIN network before the next scheduled transaction, the merchant may never see the stop payment request on the Visa network. The transaction may be erroneously authorized, effectively “bypassing” the stop payment request. This problem is exacerbated by the fact that some payment rails require a prior transaction to even submit a stop payment request, thereby limiting an issuing bank's options for preventing such a bypassed transaction. Moreover, merchants may provide slightly different identifiers (i.e., listed entity names such as “ABC, Co.” on one network rail and “The ABC Company” on a second network rail)) for each payment rail on which they operate, making it difficult for issuing banks to make sense of the various transactions provided by all of the payment rails. Bypassed stop payment requests are problematic for cardholders. Having previously instructed that the payments not be made, posting of these undesired transactions may cause confusion and dissatisfaction, waste time and resources, and otherwise worsen the experience of affected cardholders. For example, bypassed stop payment requests can produce increased traffic to call centers and network resources for self help of the issuing bank, wasted transaction processing resources that expend precious system of record resources, wasted computer resources undoing the payments, as well as numerous other issues.

In order to address the aforementioned deficiencies, as well as others, the present disclosure provides techniques for identifying transactions that have bypassed a stop payment request so that those bypass transactions can be halted, preferably before being noticed by the cardholder. In some implementations, the techniques may utilize transactional event data associated with the original stop payment request to determine whether a new transaction is associated with a prior stop payment request. After making this determination, corrective action may then be undertaken, as will be further discussed. While the examples of the present disclosure predominantly relate to payment card transactions, such as debit card transactions, it should be appreciated that the teachings described herein may also be applicable to other financial transaction types, such as ACH payments, wire transfers, Real-Time Payments (RTP), cryptocurrency transactions, and FedNow payments, that utilize stop payment requests or similar features.

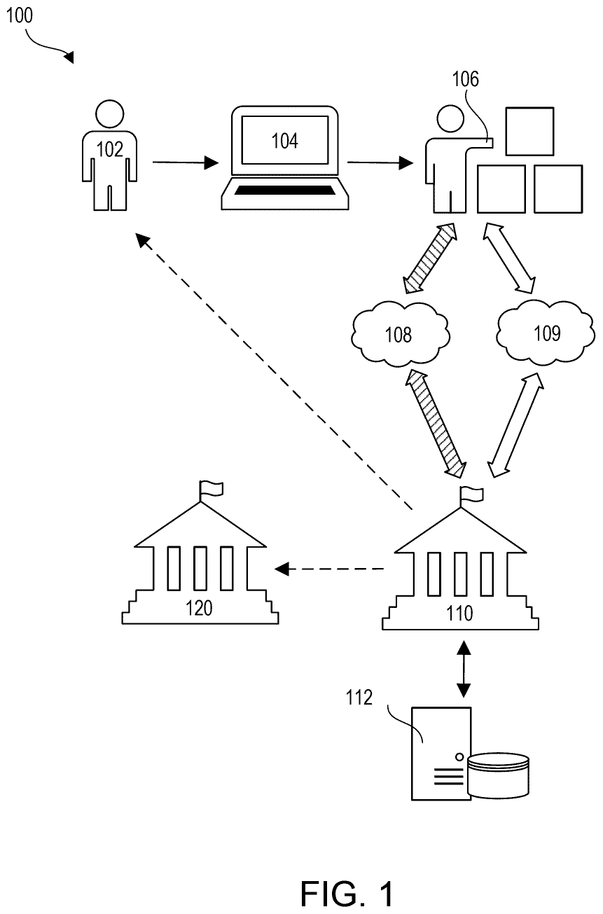

FIG. 1 depicts a debit card transaction system 100 as an example of a payment card system. As shown, a customer 102 (i.e., cardholder) may access a merchant's application or website to purchase a desired good or service (e.g., a new pair of shoes) through an electronic device 104 (e.g., computer, mobile phone). When doing so, the customer 102 may be required to enter card specific information, including the card number, expiration date, and a CVV code. While an online transaction is depicted, it should readily be appreciated that this transaction may instead be made at a physical point-of-sale device (e.g., credit card terminal) in a store, such as by swiping the card, and that such an in-person transaction may rely on a personal identification number (PIN) in place of the CVV. Similarly, although a debit card transaction is depicted, it should be appreciated that the transaction may instead be a credit card transaction.

After the debit card information has been entered by the customer 102 through the electronic device 104, the merchant 106 may send this data to a processor entity, which may be, for example, a payment service provider of the acquiring bank 120 or a similar entity. Instead of using the processor entity, the merchant 106 may also work directly with a network rail 108, 109 to receive authorization from the issuing bank 110. At this point, the processor (e.g., acquiring bank 120) may run various security checks on the transaction. If the transaction is determined to be legitimate and approved, on behalf of the merchant 106, the processor entity may then send an authorization request to the issuing bank 110 using a first network rail 108 (e.g., the STAR PIN network). There may be additional network rails associated with the debit card and available to the merchant 106 that are not used for the authorization request, such as a second network rail 109. As will be further described, this authorization request may include various information such as the card number, transaction amount, and merchant details.

After receiving the authorization request, the issuing bank 110 may run various checks, including determining whether the card is valid, whether there are sufficient funds available in the account of the customer 102, and whether the transaction seems legitimate. These determinations may be made automatically using the network system 112 of the issuing bank 110, which may include various computer processors. The information associated with the authorization request may be stored on the network system 112 the issuing bank 110 at this time using, for example, one or more databases. Based on the verification process, the issuing bank 110 may then send back an authorization response to the merchant 106 via the same network rail (e.g., STAR PIN). In the case of a physical transaction, the customer 102 may be required to enter their PIN securely at the point-of-sale terminal to further authenticate the transaction. If approved, the transaction may then proceed. If denied, the transaction may be declined, the customer 102 may be notified of the declined request, and the merchant 106 may request an alternative form of payment from the customer 102. This entire process may take place in a few seconds or less.

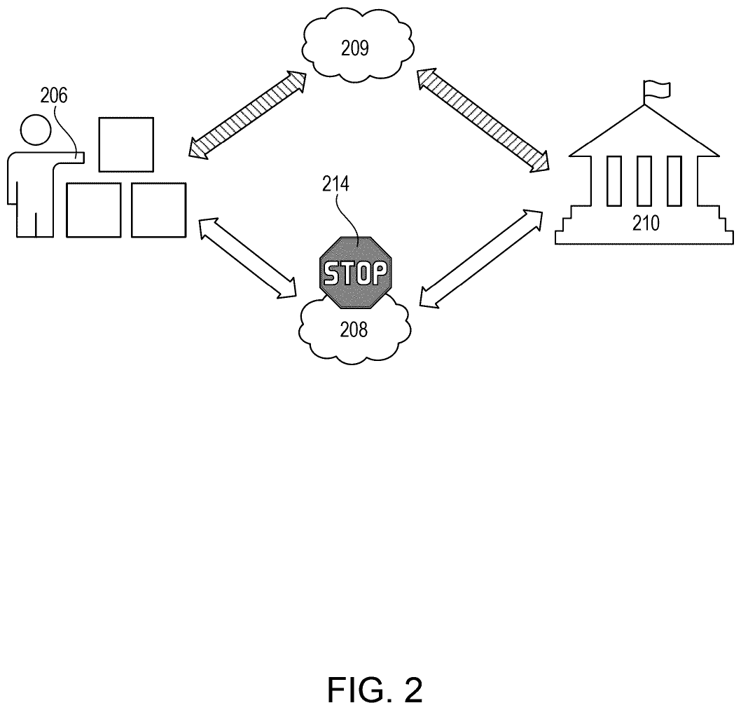

After the transaction has been approved, and at the end of the business day or at predetermined intervals, the merchant 106 may send the transaction details to the acquiring bank 120. The customer 102 may see the transaction reflected in their account statement, while the merchant 106 may receive a statement detailing all transactions processed during a specific period. As shown using dotted arrows in FIG. 1, the acquiring bank 120 may then process the transaction and initiate the transfer of funds from the issuing bank 110 to the merchant's bank account, and the issuing bank 110 may deduct the transaction amount from the customer's account balance. In the case of a credit card transaction, the cardholder would instead receive a credit card statement that includes the transaction. These settlement process between the issuing bank 110 and the acquiring bank 120 may alternatively be facilitated by the first network rail 108. As will be further explained with reference to FIG. 2, a stop payment request may be made on the payment rails 108, 109 to prevent various transactions (including both authorization and settlement transactions) between the merchant 106 and the issuing bank 110 from being completed.

FIG. 2 depicts a stop payment request 214 on a first payment rail 208 (e.g., STAR PIN) being bypassed on a second payment rail 209 (e.g., Visa). For example, ahead of an upcoming preauthorized debit transaction (e.g., a recurring monthly subscription), a customer may have contacted the issuing bank 210 in writing to request a stop payment order 214. The issuing bank 210 may work with first payment rail 208 to place the stop payment order 214. The first payment rail 208 may be the payment rail by which prior, related transactions (e.g., prior recurring payments) have been processed. Indeed, many payment rails will not permit a stop payment request for which there is no prior transaction. Accordingly, in the depicted scenario, the issuing bank 210 may not be able to place a stop payment request on both the first payment rail 208 and the second payment rail 209. In the present example, since the last recurring payment, the merchant 206 has changed from using the first payment rail 208 to the second payment rail 209. Thus, in this depiction, despite the stop payment request on the first payment rail 208, the merchant 206 uses a second payment rail 209 to process the transaction, which goes through without interference. This produces the undesirable situation where the stop payment order 214 on the first payment rail 208 is bypassed through the use of the second payment rail 209.

With continued reference to FIG. 2, and as another example, the stop payment request 214 may have been submitted by the issuing bank 210 after authorization of a transaction has already been approved on the first payment rail 208, but before settlement of the transaction. This may occur, for instance, when a cardholder disputes a transaction appearing on their account or card statement. Similar to a bypassed stop payment request during authorization, if the merchant 206 uses a second payment rail 209 to settle the transaction, this would again produce the undesirable situation where the stop payment order 214 on the first payment rail 208 is bypassed through the use of the second payment rail 209. A bypassed stop payment request during settlement would lead to a cardholder paying for the transaction even after their express refusal of the transaction.

There may be a number of reasons why the merchant 206 may use the second payment rail 209 to process the transaction. For instance, the bypassed transaction may have been inadvertent, and the merchant 206 may have simply switched payment rails as a result of the different processing fees associated with each payment rail. In other situations, the bypassed transaction may have been intentional, with the merchant 206 first attempting to process the transaction using the first payment rail 208, encountering the stop payment order 214, and then subsequently trying to again process the request using the second payment rail 209. Regardless of the intentions of the merchant 206, the resulting bypassed transaction may be undesirable for both the issuing bank 210 and the cardholder.

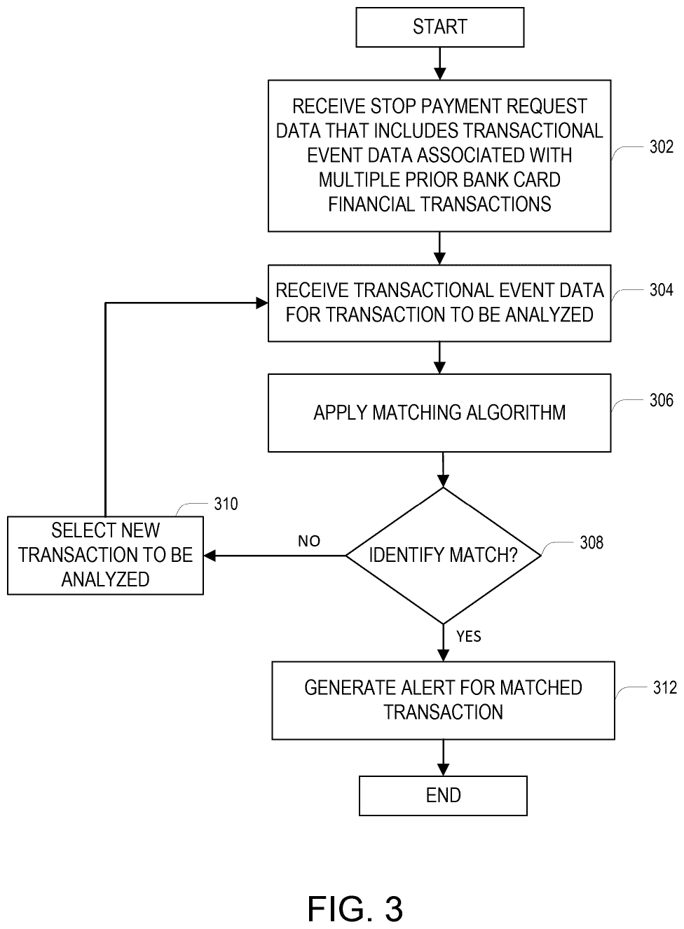

FIG. 3 depicts an operational flowchart of a technique for identifying a financial transaction that has bypassed a stop payment request. At 302, stop payment request data that includes transactional event data associated with multiple prior bank card financial transactions may be received. The stop payment request data may include, for example, all stop payment requests that have been made by any customer of an issuing bank in a specific period of time (e.g., in the past 60 days). The associated prior bank card financial transactions may be transactions for which stop payment requests have been previously issued, such as disputed or recurring transactions.

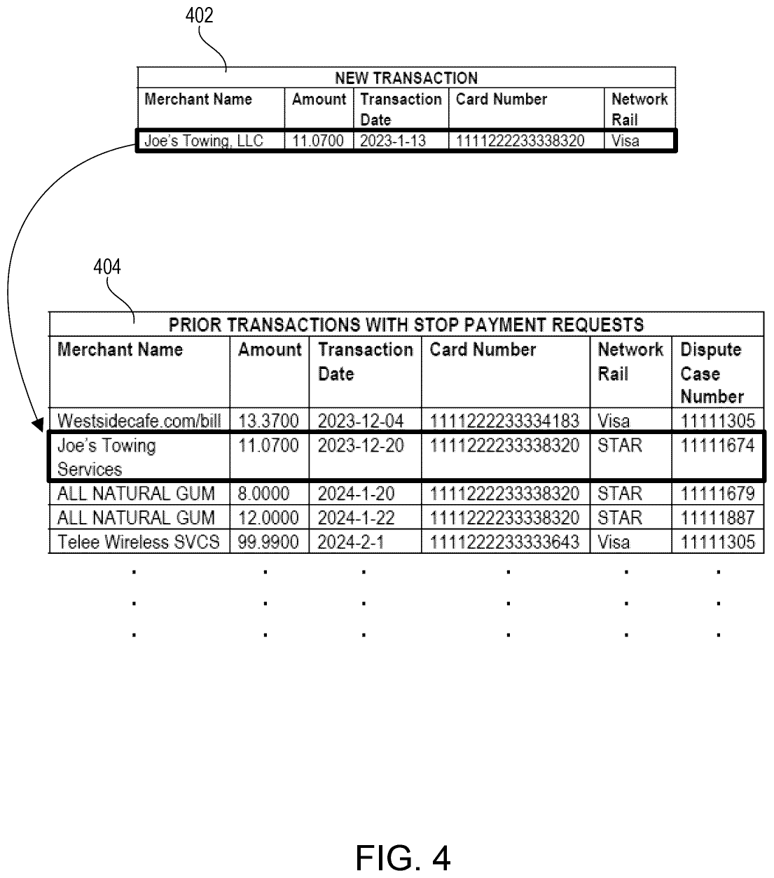

With continued reference to FIG. 3, at 304, transactional event data for a new transaction to be analyzed may be received. The new transaction may be a recent transaction, such as one selected from a list of the posted authorization transactions from the previous day. The new transaction may be at risk of being a bypassed transaction, and may need to be checked against the stop payment request data received at 302 to determine if it is indeed a transaction that has bypassed a previous stop payment order. Then, at 306, a matching algorithm may be applied to the data received at 302 and 304. The specific data used and the process for determining whether a match has occurred are discussed in further detail below, with reference to FIG. 4.

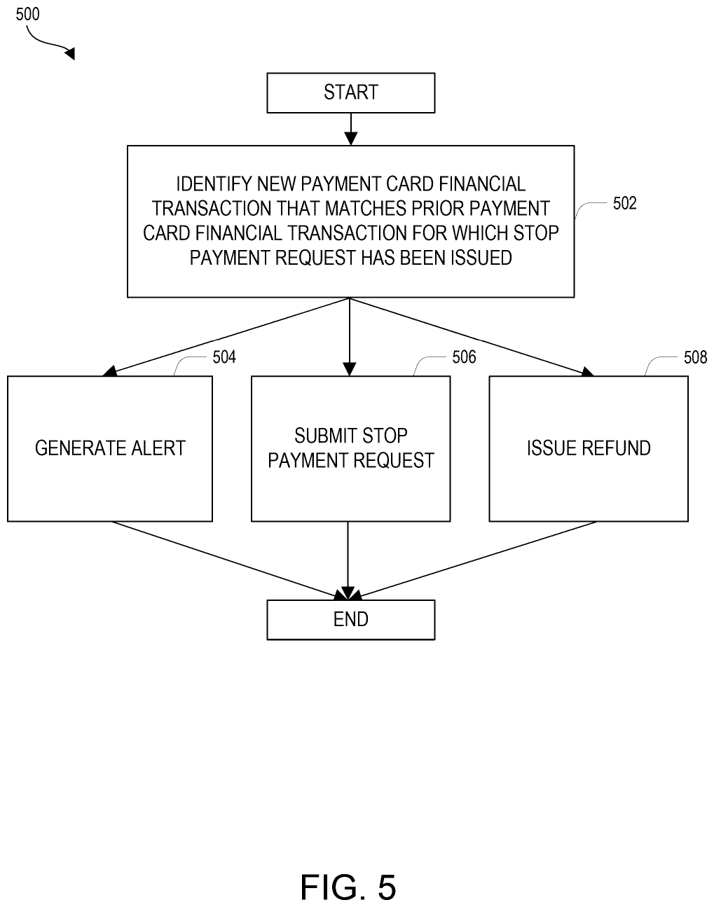

If a match is not identified at 308, then the analyzed transaction is determined to be unassociated with any of the stop payment request data received at 302. In other words, that particular new transaction has not bypassed a stop payment request made by a customer. At 310, a new transaction may be selected to be analyzed. For instance, the newly selected transaction may be taken from a list of the posted transactions from the previous day. At this point, items 304-308 may be repeated to determine if the newly selected transaction is a bypassed transaction. This process may be repeated, for example, until all posted transactions from the previous day have been analyzed. Each time a match is identified at 308, corrective action may be taken. For example, at 312, an alert may be generated for a matched transaction (i.e., a bypassed transaction) to inform an interested entity (i.e., an employee of the issuing bank, the network rail provider) that a stop payment order has been undesirably bypassed. Further corrective actions are discussed below with respect to FIG. 5.

FIG. 4 depicts a matching process between a dataset containing stop request transactional event data 404 and newly posted transactional event data 402. As shown, various transactional event data may be used to match a new transaction to a prior transaction for which a stop payment request has been made. For instance, merchant identifiers (e.g., merchant names), the transaction amounts, the transaction dates, the type of transaction (e.g., PIN vs. signature), the card number, and the network rails relied on may all be used to determine if the new payment card financial transaction 402 matches a prior payment card financial transaction 404 for which a stop payment request has been issued. Other information associated with the transaction may also be used, such as a transaction identifier and the account number of the cardholder. The stop request transactional event data 404 may include all prior payment card financial transactions for which stop payment requests have been submitted by the payment card issuer in at least the past 30 days, or more specifically in at least the past 60 days.

The matching process may occur, for example, on a processor of the issuing bank, and may receive the transactional event data from one or more network databases. Any suitable data matching algorithm known in the art may be employed, provided that it may accurately identify matching transactional event data. For example, the matching algorithm may function to determine if various transactional event data (e.g., card number, amount, merchant identifier) are identical or substantially similar. If a sufficient number of transactional event data is identified as such (e.g., identical card number, identical amount, substantially similar merchant identifier), the matching algorithm may determine a match between the data associated with two transactional events.

Given that each merchant may provide different identification information to each network rail, two matched transactions may not always perfectly align. For instance, while the card number and amount may be identical between two associated transactions, the merchant's identifier may be slightly different, as shown in the two matched transactions of FIG. 4. Accordingly, analyzing the new transactional event data 402 and the stop payment request data 404 may include applying a matching algorithm to match the merchant identifier of the new payment card financial transaction 402 with a nonidentical merchant identifier of the prior payment card financial transaction. In order to ensure that each bypassed transaction is correctly identified, the matching algorithm may apply, for example, a common key method, an edit distance method, a statistical similarity method, or a word embedding method to match each merchant identifier. In this manner, the techniques described herein may absorb merchant name changes and still successfully identify any transactions that bypasses a first network rail using a second network rail.

FIG. 5 depicts an operational flowchart of corrective actions that may be taken once a financial transaction that has bypassed a stop payment request has been identified. At 502, a new payment card financial transaction that matches a prior payment card financial transaction for which a stop payment request or order has been issued may be identified. At 504, an alert may be generated and provided to various interested entities, including the issuing bank, the network rail provider, the merchant, and/or the cardholder. The alert may be provided in the form of an email, a message, a printed communication, or a generated file. For example, each bypassed transaction and its associated information may be generated in a spreadsheet file that may be reviewed by, for example, an employee of the issuing bank. After receiving the alert, an employee may then manually take corrective action, such as by contacting the network rail provider or the cardholder. The technique may automatically provide this alert to interested parties, such as by sending a message to the cardholder via email or an in-application communication.

In addition or alternatively to the generated alert, at 506, a new stop payment request may be submitted on the second payment rail that was used to bypass the stop payment order on the first payment rail. This request may be made automatically, based on the new transactional event data received. For example, after matching a new transaction made on the Visa network rail to a prior transaction for which a stop payment order has been issued on the STAR PIN network rail, the technique may automatically generate and submit a stop payment request through the Visa network system. Similarly, at 508, corrective action to recompensate the cardholder may be additionally or alternatively taken. For instance, a refund for the amount of the new transaction may be automatically provided to the cardholder's account.

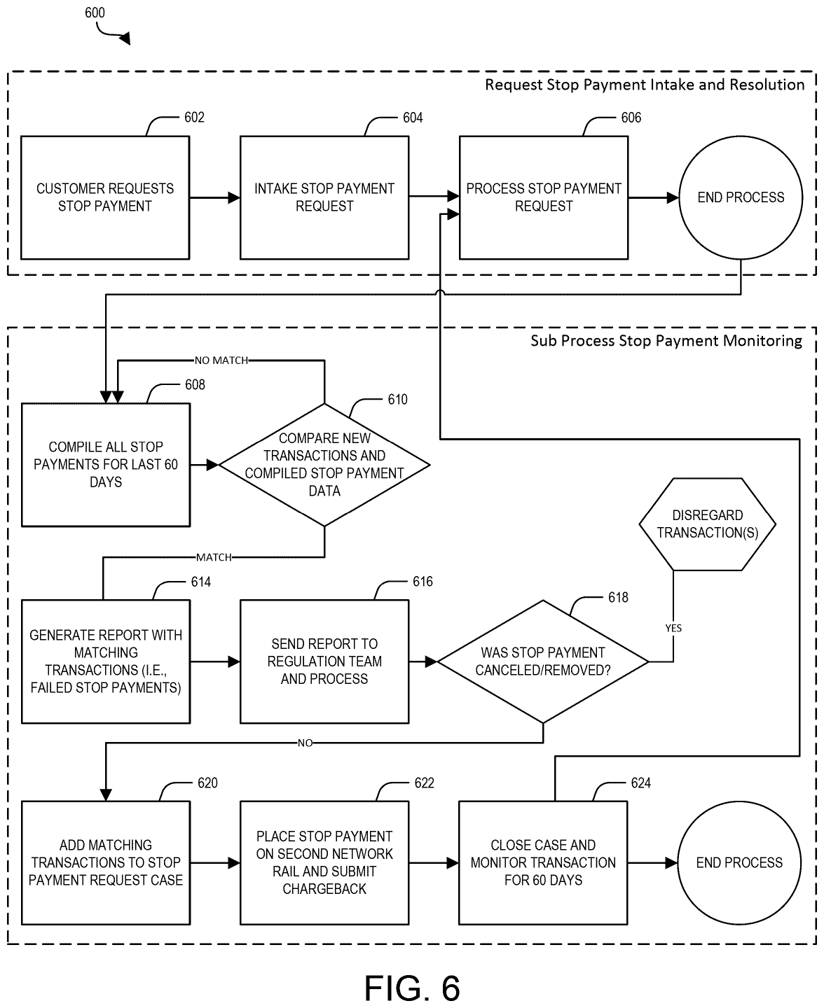

FIG. 6 depicts a flowchart 600 of an example process for identifying and addressing stop payment requests that have been bypassed on a second payment rail in a debit card transaction system. The flowchart 600 includes two different process groupings, including items associated with an overall “Request Stop Payment Intake and Resolution” process, as well as items associated with a “Sub-Process ‘Stop Payment Monitoring.’” In general, the sub-process may function to support the overall stop payment intake and resolution processes by identifying bypassed stop payment requests and taking corrective action through manual and/or automated techniques.

At the beginning of the method 600, a cardholder (e.g., customer) requests a stop payment on a posted transaction, at 602, such as by contacting a financial institution for which a payment card financial transaction will be associated with. At 604, the financial institution may intake the stop payment request. Then, at 606, the financial institution may process the stop payment request using, for example, an internal dispute case management system. Processing the stop payment request may include submitting a stop payment request to a payment rail system based on the information provided by the cardholder regarding the payment card financial transaction.

As part of the stop payment monitoring sub-process, at 608, all successfully-placed stop payments from the last 60 days, for example, may be compiled, such as into a single data table. At 610, the compiled stop payment data may be compared to the new transactions received by the financial institution, such as the daily new financial transactions. If there are no matches, then the system may be repeated until all transactions have been compared, a process that may be rerun each day or at a different time interval. If there are matches between the compiled stop payment data and the new financial transactions then, at 614, a report with matching transactions (i.e., transactions that have bypassed a stop payment request) may be generated. At 616, the report may, for example, be sent to a regulation team or an automated processing program within the financial institution. As part of the processing, at 618, it may be determined whether the stop payment request was canceled or removed, such as by the request of the cardholder. If the stop payment request was removed, the transaction may be disregarded, as shown. If the stop payment request was not removed or canceled, at 620, the matching transactions may be added to the stop payment request case. Then, at 622, a stop payment may be placed on a second network rail (i.e., the rail that the new matching transaction was completed on), and a chargeback may be submitted to the cardholder. Finally, at 624, the case may be closed and the transaction may be monitored for a set period of time, such as 60 days. The new stop payment on the second network rail may be added to the system such that it may be included in future compiled stop payments for the last 60 days.

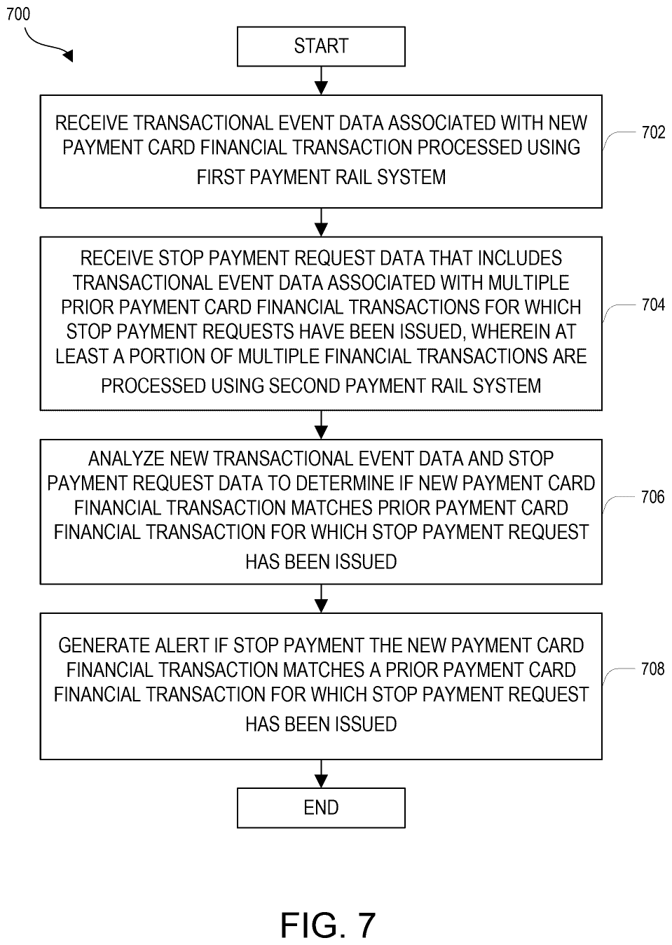

In accordance with the systems and methods described herein, FIG. 7 depicts a computer-implemented method 700 for identifying a financial transaction that has bypassed a stop payment request. The method may be implemented on, for example, a processor or a computer system of an issuing bank that submitted the stop payment request. At 702, transactional event data associated with a new payment card financial transaction processed using a first payment rail system may be received. At 704, stop payment request data that includes transactional event data associated with multiple prior payment card financial transactions for which stop payment requests have been issued may also be received. At least a portion of these multiple financial transactions may be processed using a second payment rail system. Next, at 706, the new transactional event data and the stop payment request data may be analyzed to determine if the new payment card financial transaction matches a prior payment card financial transaction for which a stop payment request has been issued. Then, at 708, an alert may be generated if the new payment card financial transaction matches a prior payment card financial transaction for which a stop payment request has been issued. Alternatively or additionally to generating the alert, the method may further include issuing a stop payment request to the first payment rail system based on the new payment card financial transaction, and/or issuing a refund to the statement of a payment cardholder for the amount of the new payment card financial transaction. The new transactional event data and the stop payment request data may include merchant identifier information, the amount, and the card number associated with each payment card financial transaction, as previously described herein.

In accordance with the teachings already described herein, in one aspect, a secure payments network is provided. The secure payments network may include a secure network device software package configured to enable a secure network device to selectively transmit payment card transactional data to one or more secure end points across a first secure network that includes a first secure end point addressable by a first end point identifier and a second secure end point addressable by a second end point identifier, and a second secure network that is logically separate and distinct from the first secure network, wherein the first and second secure end points are addressable on the second secure network. The secure payments network may also include one or more processors within the first secure end point and coupled to at least one data store storing instructions, which when loaded into at least one memory and executed by the one or more processors cause the one or more processors to receive first transactional event data involving a first transactional event via the first secure network, receive a stop payment instruction associated with the first transactional event, analyze second transactional event data involving a plurality of second transactional events received from the second secure network to determine if a match exists between the second transactional events and the first transactional event associated with the stop payment instruction, and generate an alert upon determining that any of the plurality of second transactional events correspond with the stop instruction request associated with the first transactional event.

The one or more processors may further transmit the generated alert to the second end point via the first secure network. The one or more processors further transmit the generated alert to a network administrator of the first secure network. For instance, the generated alert may be transmitted to an administrative display user interface of an administrative terminal within the first secure end point. Alternatively or additionally, the generated alert may be transmitted to the network administrator as a new stop payment request for the first secure network. The one or more processors may further issue a refund to the statement of a payment cardholder for the amount associated with the first transactional event.

In the secure payments network, the first secure end point may be a first financial institution that issued a payment card associated with the first transactional event. The generated alert may be provided to an operator of the first financial institution. The second secure end point may be a second financial institution that processes the first transactional event on behalf of a merchant. The first transactional event data may originate from a point-of-sale terminal of the merchant. Alternatively, the first transactional event data may originate from an online payment gateway of the merchant.

The first transactional event data and the plurality of second transactional event data may be matched using a merchant identifier. In particular, analyzing the second transactional event data may include determining the merchant identifier associated with the first secure network, determining the merchant identifier associated with the second secure network, and applying a matching algorithm to match the merchant identifier of the first secure network with the merchant identifier of the second secure network. The merchant identifier of the first secure network and the merchant identifier of the second secure network may not necessarily be identical. The matching algorithm may apply a common key method, an edit distance method, a statistical similarity method, or a word embedding method. Alternatively or additionally, the first transactional event data and the plurality of second transactional event data may be matched using an account number or the card number associated with each transactional event. Alternatively or additionally, the first transactional event data and the plurality of second transactional event data may be matched using the amount associated with each transactional event. The first transactional event data may include a debit card transaction. The debit card transaction may specifically be an online transaction.

In yet another aspect, the present provides a secure payments network. The secure payments network may include one or more processors within a first secure end point and coupled to at least one data store storing instructions, which when loaded into at least one memory and executed by the one or more processors cause the one or more processors to receive first transactional event data involving a first transactional event via a first secure network, the first secure network that includes a first secure end point addressable by a first end point identifier and a second secure end point addressable by a second end point identifier, receive a stop payment instruction associated with the first transactional event, analyze second transactional event data involving a plurality of second transactional events received from a second secure network to determine if a match exists between the second transactional events and the first transactional event associated with the stop payment instruction, wherein the second secure network is logically separate and distinct from the first secure network and the first and second secure end points are addressable on the second secure network, and generate an alert upon determining that any of the plurality of second transactional events correspond with the stop instruction request associated with the first transactional event.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGA s) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGA s with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The computing systems described herein can be generally controlled and coordinated by operating system software, such as IOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file systems, networking, I/O services, and provide a user interface functionality, such as a graphical user interface (“GUI”), among other things.

Furthermore, although aspects of the disclosed embodiments may be associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

It is claimed:

1. A secure payments network comprising:
a secure network device software package configured to enable a secure network device to selectively transmit payment card transactional data to one or more secure end points across:
a first secure network that includes a first secure end point addressable by a first end point identifier and a second secure end point addressable by a second end point identifier; and
a second secure network that is logically separate and distinct from the first secure network, wherein the first and second secure end points are addressable on the second secure network;
one or more processors within the first secure end point and coupled to at least one data store storing instructions, which when loaded into at least one memory and executed by the one or more processors cause the one or more processors to:
receive first transactional event data involving a first transactional event via the first secure network;
receive a stop payment instruction associated with the first transactional event;
analyze second transactional event data involving a plurality of second transactional events received from the second secure network to determine if a match exists between the second transactional events and the first transactional event associated with the stop payment instruction; and
generate an alert upon determining that any of the plurality of second transactional events correspond with the stop instruction request associated with the first transactional event.

2. The secure payments network of claim 1, wherein the one or more processors further transmit the generated alert to the second end point via the first secure network.

3. The secure payments network of claim 1, wherein the one or more processors further transmit the generated alert to a network administrator of the first secure network.

4. The secure payments network of claim 3, wherein the generated alert is transmitted to an administrative display user interface of an administrative terminal within the first secure end point.

5. The secure payments network of claim 3, wherein the generated alert is transmitted to the network administrator as a new stop payment request for the first secure network.

6. The secure payments network of claim 1, wherein the one or more processors further issue a refund to the statement of a payment cardholder for the amount associated with the first transactional event.

7. The secure payments network of claim 1, wherein the first secure end point is a first financial institution that issued a payment card associated with the first transactional event.

8. The secure payments network of claim 6, wherein the generated alert is provided to an operator of the first financial institution.

9. The secure payments network of claim 6, wherein the second secure end point is a second financial institution that processes the first transactional event on behalf of a merchant.

10. The secure payments network of claim 8, wherein the first transactional event data originates from a point-of-sale terminal of the merchant.

11. The secure payments network of claim 8, wherein the first transactional event data originates from an online payment gateway of the merchant.

12. The secure payments network of claim 1, wherein the first transactional event data and the plurality of second transactional event data are matched using a merchant identifier.

13. The secure payments network of claim 11, wherein analyzing the second transactional event data includes:
determining the merchant identifier associated with the first secure network;
determining the merchant identifier associated with the second secure network; and
applying a matching algorithm to match the merchant identifier of the first secure network with the merchant identifier of the second secure network.

14. The secure payments network of claim 12, wherein the merchant identifier of the first secure network and the merchant identifier of the second secure network are not identical.

15. The secure payments network of claim 12, wherein the matching algorithm applies a common key method, an edit distance method, a statistical similarity method, or a word embedding method.

16. The secure payments network of claim 1, wherein the first transactional event data and the plurality of second transactional event data are matched using an account number or the card number associated with each transactional event.

17. The secure payments network of claim 1, wherein the first transactional event data and the plurality of second transactional event data are matched using the amount associated with each transactional event.

18. The secure payments network of claim 1, wherein the first transactional event data includes a debit card transaction.

19. The secure payments network of claim 17, wherein the debit card transaction is an online transaction.

20. A secure payments network comprising one or more processors within a first secure end point and coupled to at least one data store storing instructions, which when loaded into at least one memory and executed by the one or more processors cause the one or more processors to:
receive first transactional event data involving a first transactional event via a first secure network, the first secure network that includes a first secure end point addressable by a first end point identifier and a second secure end point addressable by a second end point identifier;
receive a stop payment instruction associated with the first transactional event;
analyze second transactional event data involving a plurality of second transactional events received from a second secure network to determine if a match exists between the second transactional events and the first transactional event associated with the stop payment instruction, wherein the second secure network is logically separate and distinct from the first secure network and the first and second secure end points are addressable on the second secure network; and
generate an alert upon determining that any of the plurality of second transactional events correspond with the stop instruction request associated with the first transactional event.
